(19) United States
(12) Patent Application Publication
(10) Pub. No.: US 2009/0199132 A1
(43) Pub. Date: Aug. 6, 2009

(54) QUICK ACCESS TO VIRTUAL APPLICATIONS

(75) Inventors: Benedict T. CHONG, San Jose, CA (US); Mark M. Lee, Saratoga, CA (US); Robert Ha, Saratoga, CA (US); Philip Sheu, San Jose, CA (US); Thomas Deng, Cupertino, CA (US); Victor E. Chin, San Jose, CA (US)

Correspondence Address: GLENN PATENT GROUP, 3475 EDISON WAY, SUITE L, MENLO PARK, CA, 94025, US

(73) Assignee: DeviceVM, Inc., San Jose, CA (US)

(21) Appl. No.: 12/369,226

(22) Filed: Feb. 11, 2009

Related U.S. Application Data
(63) Continuation-in-part of application No. 12/200,758, filed on Aug. 28, 2008.
Application No. 12/200,758 is a continuation of application No. 11/772,700, filed on Jul. 2, 2007, now Pat. No. 7,441,113.
(60) Provisional application No. 60/806,915, filed on Jul. 10, 2006.
(60) Provisional application No. 60/890,121, filed on Feb. 15, 2007.

(51) Int. Cl. G06F 9/00; G06F 3/048

(52) U.S. Cl. 715/810; 713/2

(57) ABSTRACT

An embedded operating system (OS) displays a user interface (UI) without waiting for the host OS to fully load. In one embodiment, the UI comprises icons for applications, advertisements, and browsers already configured with a URL. In one embodiment, the pre-configured browsers are set by the manufacturer. In another embodiment, the user can specify pre-configured browsers. In one embodiment, the icon owner pays for displaying an icon. The icon can be a static or a dynamic icon. Dynamic icons are downloaded from a file server.

### CROSS REFERENCE TO RELATED APPLICATIONS

This patent application is a continuation-in-part of U.S. patent application Ser. No. 12/200,758, Method and Apparatus for Virtualization of Appliances, filed Aug. 28, 2008, which is a continuation of U.S. Pat. No. 7,441,113, Method and Apparatus for Virtualization of Appliances, filed Jul. 2, 2007 and which claims priority to U.S. provisional patent application Ser. No. 60/806,915, Method and Apparatus for Virtualization of Applications, filed Jul. 10, 2006; U.S. provisional patent application Ser. No. 60/890,121, Instant On Appliances, filed Feb. 15, 2007; and U.S. provisional patent application Ser. No. 60/975,724, Quick Searching Facility for a Virtualized Environment, filed Sep. 27, 2007, the entirety of each of which is incorporated herein by this reference thereto.

### BACKGROUND OF THE INVENTION

1. Technical Field

The invention relates to virtualization. More particularly, the invention relates to a method and apparatus for quick access to virtual applications.

2. Description of the Prior Art

In computing, virtualization is a broad term that refers to the abstraction of computer resources. One useful definition is a technique for hiding the physical characteristics of computing resources from the way in which other systems, applications, or end users interact with those resources. This term has been widely used since the 1960s or earlier, and has been applied to many different aspects and scopes of computing, from entire computer systems to individual capabilities or components. The common theme of all virtualization technologies is the hiding of technical detail, through encapsulation. Virtualization creates an external interface that hides an underlying implementation, e.g. by multiplexing access, by combining resources at different physical locations, or by simplifying a control system.

One application of virtualization technology is to provide direct access to applications without waiting for the host operating system (OS) to load. This is advantageous for users that want, quick access to an application, e.g. the Internet. Thus, one goal in virtualization technology is to provide a program and corresponding interface that minimize the time between starting a computer and displaying a user interface.

Currently, a user presses the power button or a hot-key to boot the virtualization software and the user is presented with a screen that contains a list of all applications. If the user wants to access a particular website, for example, the user must select the Internet application, wait for it to load, and then enter the desired Uniform Resource Locator (URL). As a result, even though the user does not have to wait for the operating system to load, the user may still find this process too time consuming.

### SUMMARY OF THE INVENTION

The invention comprises a first electronic programming guide (EPG1) that displays a user interface (UI) mere seconds after the user turns on the computer. The EPG UI displays icons representing applications. The applications can include virtual appliances, which are self-contained programs. In one embodiment, virtual appliances are downloaded from a file server. In another embodiment, the applications are stored locally.

In one embodiment, the icon is static. In another embodiment, the icon is dynamic. Dynamic icons include short pieces of animation and video clips. Dynamic icons are downloaded from a server that obtains information from the icon owner, e.g. advertiser. In one embodiment, an icon comprises instructions for launching a browser pre-loaded with a URL. These icons provide an opportunity for monetization by requiring a fee for display or a fee for a click-through.

The icons include websites, applications, advertisements, etc. If a company pays to have their icon displayed, they can pay a flat fee or they can subscribe to have the icon displayed for a certain period of time. In one embodiment, icons are displayed according to start and end dates. Advertisements are timed for certain events, for example, to generate interest in an upcoming movie.

Once the user selects an icon from the EPG UI, the EPG1 passes the instructions to an EPG2, which loads and launches the appropriate application. If the selected application is not accessible locally, then it is downloaded, e.g. over the Internet from a file server. The user can also elect to boot the host OS from the hard disk, if a host OS and hard disk are installed, or to power-off the system.

### BRIEF DESCRIPTION OF THE DRAWINGS

FIG. 1 is a block diagram that illustrates a system for running a virtualized environment according to one embodiment of the invention;

FIG. 2 is a block diagram that illustrates a software stack stored on a client 100 according to one embodiment of the invention;

FIG. 3 is an example of a electronic programming guide user interface according to one embodiment of the invention;

FIG. 4 is a flow diagram that illustrates the steps for operating the virtualized environment according to one embodiment of the invention;

FIG. 5 is a bloc diagram that illustrates a system for generating a dynamic icon and recording a click-through according to one embodiment of the invention;

FIG. 6A is a flow diagram that illustrates the steps for generating a dynamic icon according to one embodiment of the invention; and

FIG. 6B is a flow diagram that illustrates the steps for launching a landing page and recording a click-through according to one embodiment of the invention.

### DETAILED DESCRIPTION OF THE INVENTION

### Hardware

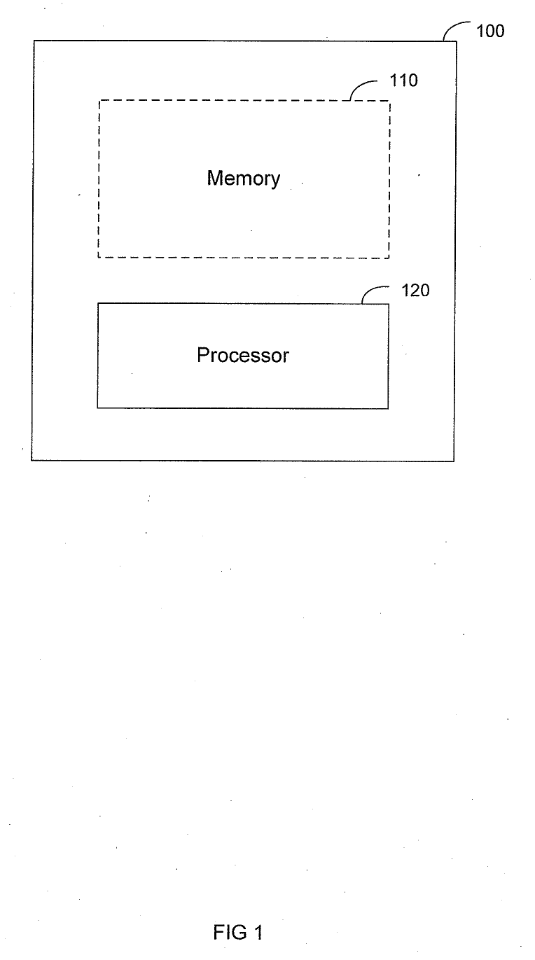

FIG. 1 is a block diagram that illustrates hardware for running a virtualized application environment according to one embodiment of the invention. The client 100 is a computing platform configured to act as a client device, e.g. a computer, a digital media player, a personal digital assistant, a cellular telephone, etc. The client 100 may include a number of external or internal devices, e.g. a mouse, a keyboard, a display device, etc.

The client 100 includes a computer-readable medium 110, e.g. random access memory (RAM), coupled to a processor 120. The processor 120 executes computer-executable program code stored in memory 110. Other embodiments of a computer-readable medium 110 include, but are not limited to, an electronic, optical, magnetic, or other storage or transmission device capable of coupling to a processor, e.g. flash drive, CD-ROM, DVD, magnetic disk, memory chip, ROM, etc.

### Virtualization Components

The invention provides the user with all the functionality associated with a host OS, without having to wait for the host OS to load. The invention comprises three components: a boot loader, EPG1, and EPG2.

The boot loader is an embedded OS that is integrated into the system boot firmware, e.g. basic input/output system (BIOS). The boot loader suspends the host OS and installs the necessary drivers for network access and graphics displays from the boot read only memory (ROM). The boot loader retrieves the EPG1 from the BIOS ROM or other storage media and launches the EPG1.

The EPG1 comprises a user interface (UI) that displays icons as graphical representations of the virtual applications. When the user selects an icon, EPG1 loads the EPG2. In one embodiment, the EPG2 is a Linux-based environment that resides on a mass storage device. The mass storage device is typically either a hard drive or a flash memory embedded on the motherboard. The EPG2 can also load from an external device, e.g. a flash drive.

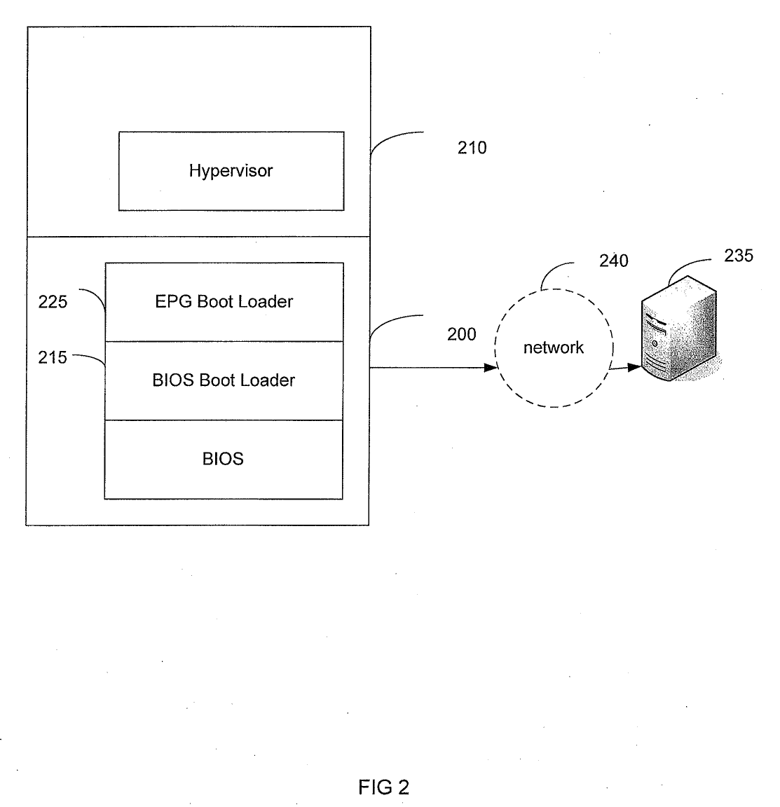

FIG. 2 is a block diagram that illustrates a software stack stored on a client 100 according to one embodiment of the invention. The EPG1 and EPG2 can use a variety of sources for storing and caching pieces of data or applications. In one embodiment, the BIOS Flash ROM stores a Complimentary Metal Oxide Semiconductor (CMOS), extended system configuration data (ESCD), boot loader, and BIOS. The virtual appliances can be stored in built-in storage, removable storage, or online storage.

The client 100 should support a dynamic host configuration protocol (DHCP), which allows a client 100 on a local network to assign temporary IP addresses to other clients. The software stack comprises a portion that is maintained in BIOS flash memory 200 and a portion that is downloaded 210.

The BIOS boot loader 215 loads and executes the master boot region (MBR) from a ROM/Flash disk. If a hidden partition area (HPA) is present and supported by the BIOS, the BIOS executes the HPA content. In another embodiment, control is transferred to the boot loader 225 by incorporating pre-boot eXecution Environment (PXE) protocols into the boot loader and replacing the standard network interface card option ROM with a virtualization option ROM. This reduces the amount of BIOS customization and overall ROM space required.

In one embodiment, the boot loader 215 loads the EPG1 from the BIOS flash. The embedded OS provides the necessary services (SATA, USB, etc.) for loading the EPG1. In another embodiment, the EPG1 is downloaded from a file server 235 across a network 240. The network 240 comprises the Internet. In another embodiment, the network 240 is a local area network (LAN), a wide area network (WAN), a home network, etc. In one embodiment, the network 240 is implemented via wireless connections.

### EPG1 UI

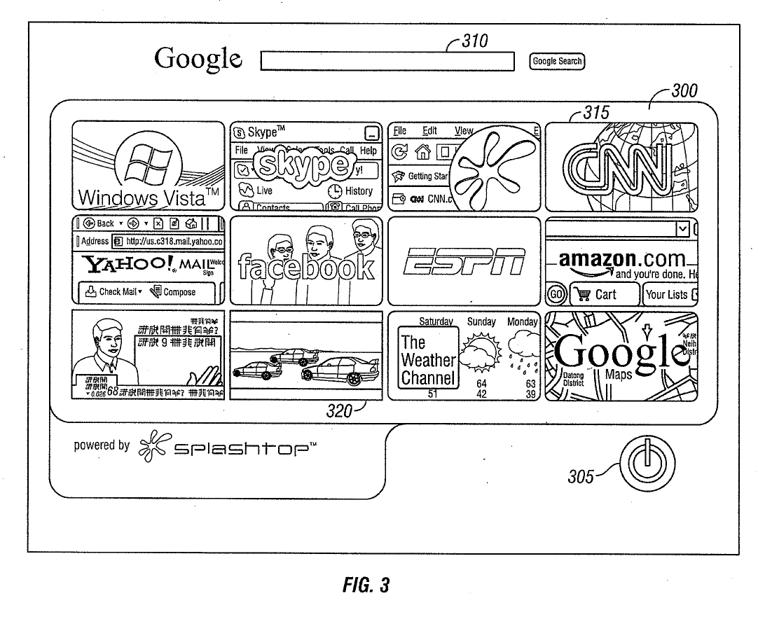

The EPG1 UI contains icons for favorite websites and applications. The URL associated with the icon is called the landing page. FIG. 3 is an example of an EPG1 UI according to one embodiment of the invention. The UI includes an icon section 300, a power button 305, and a quick search text box 310. The quick search text box allows a user to use a search engine from the UI. Quick Search is discussed in-depth in U.S. patent application Ser. No. 12/239,687, the entirety of which is incorporated herein by this reference thereto.

When a user clicks on one of the icons for a website, for example the CNN icon, the EPG1 boots the EPG2 and passes the parameter specifying request to the EPG2, which launches an application, e.g. a web browser that automatically loads the landing page. The user can choose among other favorites, e.g. Yahoo Mail, facebook, ESPN, Amazon, the Weather Channel, Google Maps, etc. Alternatively, the user can select an icon for an application such as Skype, choose to load the host OS, e.g. Windows, or turn off the computer 305.

The number of icons contained in the icon section 300 is a function of the amount of screen space and the need to avoid overcrowding. The problem of overcrowding is especially significant when icon owners pay money to have their icon displayed. The more icons displayed, the lower the value of each individual icon.

In one embodiment, the icon contains an image associated with the publisher of the landing page, e.g. CNN 315. In another embodiment, the icon is an animated icon, for example, in FIG. 3 the icon of cars 320 in the bottom row depicts moving cars. In another example, the icons contain a banner that displays current headlines.

In one embodiment, a user has permission to configure this page with favorite icons. Although this decreases monetization opportunities, it provides the user with a potentially more useful format. Thus, in one embodiment the UI contains default icons and the user can replace some or all of them if so desired. The user modifies the icons either while the EPG2 is running or while the host OS, e.g. Windows is running.

### Monetization

A user is much more likely to click on an icon that directly loads a landing page, rather than load the browser and then type in the website, especially when the user only has a few minutes. Thus, charging for display of the icon is an excellent opportunity for monetization. The value of the icons is even greater when powering on the computer automatically loads the icon page.

In one embodiment, a company pays a one-time fee for permanent display of an icon. The cost can be a function of the position of the icon, i.e. the first position costs more than the second, etc.

In another embodiment, a company pays a subscription fee for display of an icon for a set period of time. This is a particularly useful model for advertisements. For example, a production company reserves an icon space for the month before a new movie is released to generate interest in the movie. In another example, the icon can provide a preview for a television show that airs weekly. Thus, each week, the icon contains a clip for the show to air that week. In one embodiment, these icons are displayed according to a data stamp, which has a start date and, in one embodiment, has an ending date as well.

Another opportunity for monetization is in landing rights. When a user clicks on an icon for a website and arrives at the landing page, the system charges the publisher a fee. Landing rights provide the advantage of a recurring revenue stream.

To enable revenue for landing rights, the landing page must be able to distinguish between a user running the virtualized browser and a traditional browser. Alternatively, the publisher can provide a unique landing page for people using the virtualized browser that mirrors the content on their homepages.

### Operation Sequence

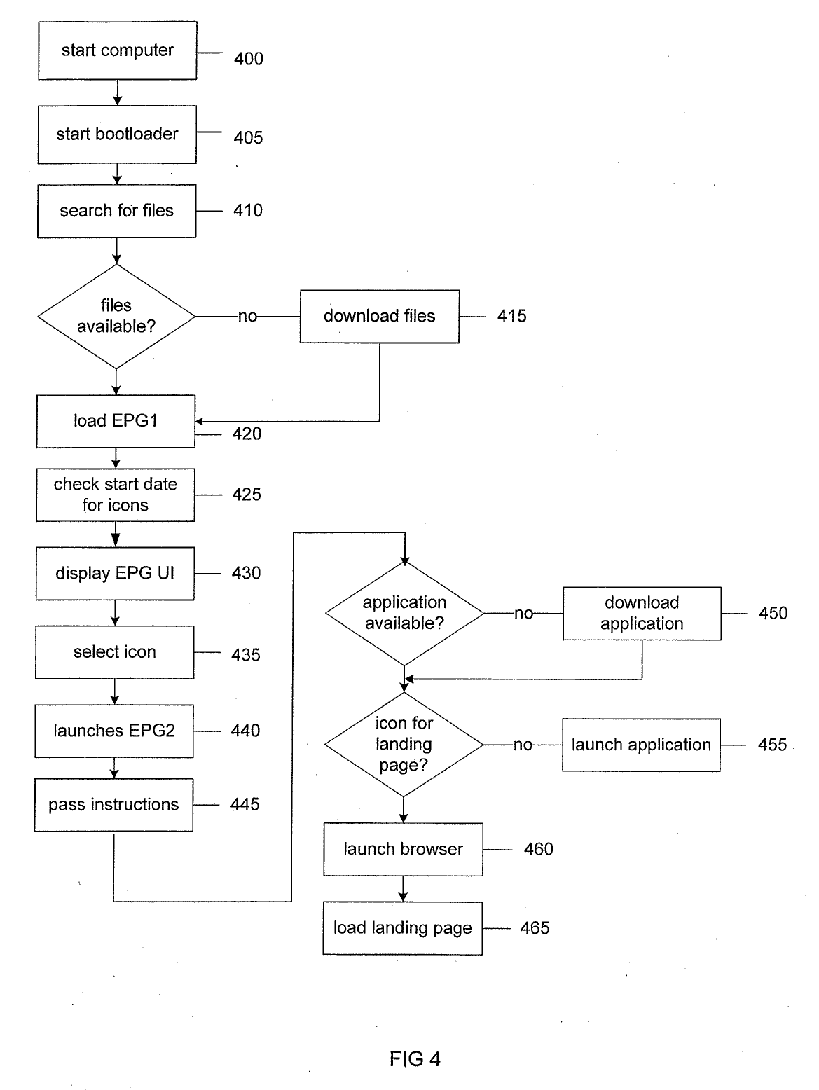

FIG. 4 is a flow diagram that illustrates the steps for operating in a virtualized environment with an EPG UI that contains icons for quick access to landing pages. The user starts 400 the client 100, either by pressing a power button or a hotkey. In one embodiment, providing only one button is more idea because it is less confusing for the user and increases the value of the icons because the user always views the icons. If the user chooses between the EPG UI and loading the host OS, there is no guarantee that the user views the icons on the EPG UI.

The boot loader is started 405. The boot loader searches for files on the hard drive, flash memory, and any attached external devices. If the files necessary for starting the EPG1 are not available on the client 100, the client 100 downloads 415 the files from the file server 235. The file server 235 is administered by the company that provides the software or the original equipment manufacturer (OEM). Once the files are located, the bootloader 100 loads 420 the EPG1 into memory. The EPG1 checks 425 whether any of the icons have an applicable start date and displays 430 the EPG UI with the corresponding icons.

The user can perform a variety of functions, including selecting 435 an icon, selecting an appliance, or shutting down the computer. The EPG1 launches 440 the EPG2. The EPG1 passes 445 the instruction to launch the application to the EPG2. The EPG2 determines whether the application is available on the client 100. In one embodiment, the applications are stored as files on a mass storage partition. If the application files are not stored on the client, the application is downloaded 450 from the file server 235. The downloaded application can be cached in local storage media such that, the next time it is needed, the application is directly accessible from memory.

The EPG2 determines whether the icon is for a landing page. If not, the EPG2 launches 455 the selected application. If yes, the EPG2 launches 460 the browser. In one embodiment the browser is Mozilla Firefox. In another embodiment, the browser is any other browser, e.g. Internet Explorer, Netscape, Safari, etc. The browser loads 465 the corresponding landing page, i.e. the URL.

### Dynamic Icon

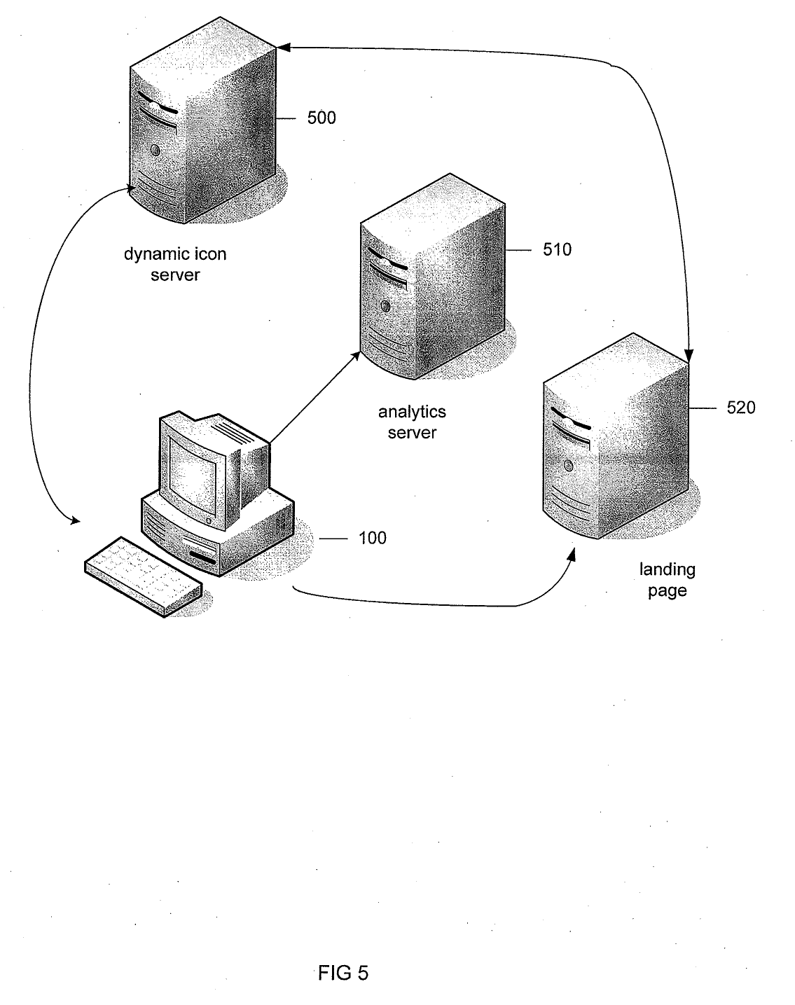

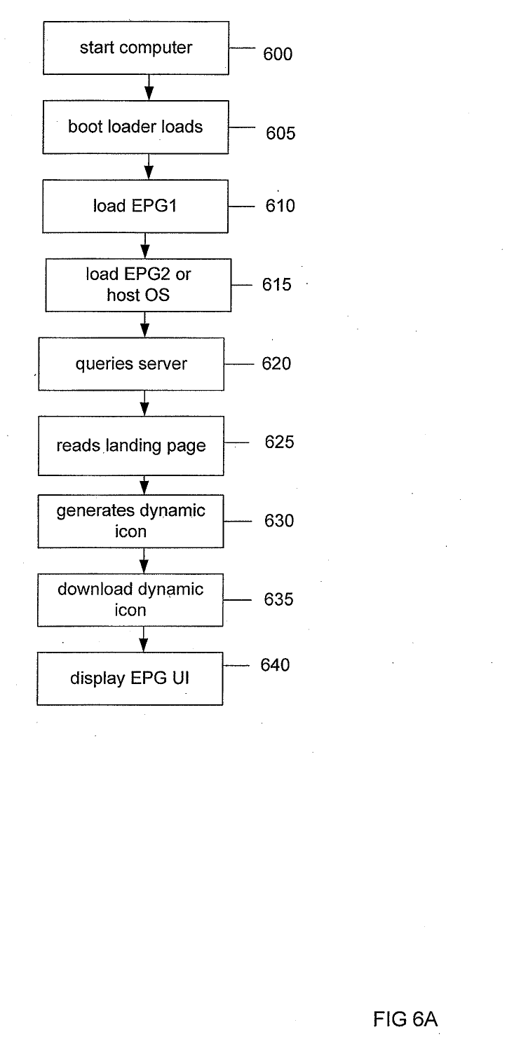

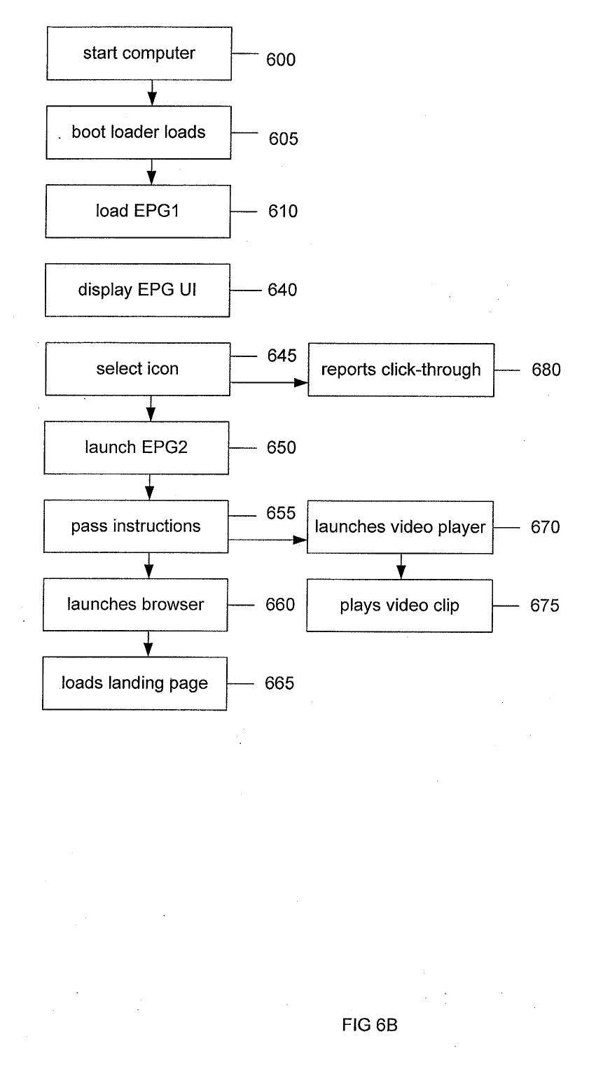

FIG. 5 is a bloc diagram that illustrates a system for generating a dynamic icon and recording a click-through according to one embodiment of the invention. FIGS. 6A and 6B are flow diagrams that illustrate the steps that correspond to the system illustrated in FIG. 5. Although three different servers are displayed in FIG. 5, a person of ordinary skill in the art will recognize that dynamic icons can also be generated by a single file server, such as the one illustrated in FIG. 2.

FIG. 6A illustrates the steps for downloading dynamic icons, including video clips according to one embodiment of the invention. A user starts 600 the computer. The boot loader loads 605 from memory. The boot loader loads 610 the EPG1. The EPG1 loads 615 the EPG2. In another embodiment, the EPG1 loads 615 the host OS, e.g. Windows. A program running on either the EPG2 or the host OS queries 620 the dynamic icon server 500 for the dynamic icon. The dynamic icon server 500 reads 625 the landing page and generates 630 the dynamic icon, e.g. an animated gif file. The EPG2 downloads 635 the dynamic icons.

These steps apply to both icons that are animated without activation and video clips. In one embodiment, the EPG1 does not play back video because it would be too demanding for the embedded OS. As a result, the video clips are a series of animated gifs that are downloaded while the user is in Windows or while the EPG2 is active.

These steps only apply to the first time the icons are available. Thus, the next time that the EPG1 is loaded, the icons are retrieved along with the other files used for displaying the UI.

FIG. 6B illustrates the steps for viewing an EPG UI with downloaded dynamic icons and video according to one embodiment of the invention. The user starts 600 the computer. The boot loader loads 605 using an embedded OS. The boot loader loads 610 the EPG1. The EPG1 displays 640 the EPG UI including the dynamic icons. The user selects 645 an icon. The EPG1 launches 650 the EPG2. The EPG1 passes 655 the instructions to the EPG2. The EPG2 launches 660 the browser. If the icon is for a specific website, the EPG2 loads 665 the landing page from the landing page server 520. If the icon is for a video clip, the EPG2 launches 670 the video player and plays 675 the video clip.

In one embodiment, an analytics server 510 monitors the number of times that a user clicks on an icon for a landing page. When the user selects 645 an icon representing a landing page, the client 100 reports 680 the click-through to the analytics server 510.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

What is claimed is:

1. A system for displaying a browser pre-loaded with a landing page before a host operating system (OS) loads, the system comprising:
a client, said client comprising:
a display device;
a system boot read only memory (ROM);
a boot loader comprising an embedded OS stored in said boot ROM, said boot loader suspending launch of said host OS and launching a first electronic programming guide (EPG1) instead;
said EPG1 comprising:
a user interface (UI) that is presented to said user on said display, said EPG1 UI comprising a plurality of icons, wherein at least one of said icons comprises a graphical representation of a browser configured to display a landing page, said landing page comprising a pre-selected Uniform Resource Locator (URL); and
a second electronic programming guide (EPG2) that is launched by said EPG1, said EPG2 for launching applications corresponding to each icon displayed on said EPG1 UI, wherein responsive to selection of an icon comprising a graphical representation of a browser with said landing page, said EPG2 launches said browser and displays said pre-selected URL.

2. The system of claim 1, further comprising a mechanism for an original equipment manufacturer (OEM) to define said pre-selected URL for each icon comprising said landing page.

3. The system of claim 2, wherein said system comprises a means for charging an icon owner a fee for each icon displayed with said icon owner's icon.

4. The system of claim 1, wherein said pre-selected URL for each icon comprising said landing page is specified by a user.

5. The system of claim 1, further comprising a means for notifying an analytics server each time a user clicks on said icon comprising a graphical representation of said browser configured to display said landing page.

6. The system of claim 1, wherein said EPG1 UI further comprises a dynamic icon that is downloaded while said EPG2 is active.

7. The system of claim 6, wherein said dynamic icon comprises a video clip.

8. The system of claim 1, said icon comprising at least one of a dynamic icon, an advertisement, a banner, and a virtual appliance.

9. The system of claim 1, said icon comprising a headline from an online news publisher.

10. A computer implemented method for using a browser to display a pre-loaded landing page before a host operating system (OS) loads, the method comprising the steps of:
loading a bootloader comprising an embedded OS stored in a boot read only memory (ROM) of a client, said bootloader suspending launch of said host OS;
said bootloader loading a first electronic programming guide (EPG1) in lieu of said host OS;
said EPG1 displaying an EPG1 user interface (UI), said EPG1 UI comprising a plurality of icons, wherein at least one of said icons comprises a graphical representation of a browser configured to display a landing page, said landing page comprising a pre-selected Uniform Resource Locator (URL);
receiving from a user a selection of said icon comprising a graphical representation of a browser configured to display a landing page;
said EPG1 loading a second electronic programming guide (EPG2);
receiving from a user a selection of said icon comprising a graphic representation of a browser configured to display a landing page;
said EPG1 passing said selection of said icon to said EPG2;
said EPG2 launching said browser; and
said browser displaying said landing page.

11. The computer implemented method of claim 10, further comprising the step of checking said icons for start dates.

12. The computer implemented method of claim 10, further comprising the steps of:
said EPG2 querying a server for a dynamic icon;
said EPG2 downloading said dynamic icon; and
displaying said EPG1 UI, said EPG1 UI comprising said dynamic icon.

13. A computer readable storage medium comprising computer executable instructions, the instructions when executed by a browser cause an application to perform the method of claim 10.

14. The computer implemented method of claim 10, further comprising the steps of:
loading said host OS;
said host OS querying a server for a dynamic icon;
said host OS downloading said dynamic icon; and
displaying said EPG1 UI, said EPG1 UI comprising said dynamic icon.

15. The computer implemented method of claim 10, further comprising the step of:
responsive to selection of an icon comprising said browser configured to display said landing page, said EPG2 notifying an analytics server of selection of said icon.

16. The computer implemented method of claim 10, further comprising the steps of:
said bootloader checking said client for a plurality of files for loading said EPG1; and
downloading said files from a file server if said files are unavailable from said client.

17. A computer implemented method for generating dynamic icons for display on a first electronic programming guide (EP1) user interface (UI) loaded from an embedded operating system (OS), the method comprising:
loading a boot loader comprising said embedded OS stored in a boot read only memory (ROM) of a client, said bootloader suspending launch of said host OS;
said boot loader loading said EPG1;
said EPG1 loading a second electronic programming guide (EPG2);
said EPG2 querying a server for at least one dynamic icon;
downloading said at least one dynamic icon from said server; and
displaying said EPG1 UI on said client, said EPG1 UI comprising said dynamic icons.

18. The computer implemented method of claim 17, wherein said dynamic icon comprises a video clip and wherein said client comprises a computer-readable storage medium.

19. The computer implemented method of claim 18 further comprising the step of:
storing said video clip on said computer-readable storage medium;
receiving a request from a user to play said video clip;
said EPG1 launching said EPG2;
said EPG2 launching a video player;
said video player retrieving said video clip from said computer-readable storage medium; and
said video player displaying said video clip.

20. The computer implemented method of claim 17, further comprising the steps of:
receiving a request from a user to launch an application associated with said dynamic icon; and
notifying an analytics server each time said user selects said dynamic icon.
